(19) United States
(12) Patent Application Publication
(10) Pub. No.: US 2023/0313531 A1
(43) Pub. Date: Oct. 5, 2023

(54) FIRE-RESISTANT MODIFIED BITUMINOUS COMPOSITIONS AND ROOFING PRODUCTS

(71) Applicant: CertainTeed LLC, Malvern, PA (US)

(72) Inventors: Ryan Balheda, Havertown, PA (US); Paul A. Benensky, Collegeville, PA (US); Nicholas David Orf, Natick, MA (US); Rachel Brown, Shrewsbury, MA (US); Ana M. Sousa, Aviero (PT)

(21) Appl. No.: 18/112,548

(22) Filed: Feb. 22, 2023

Related U.S. Application Data
(60) Provisional application No. 63/312,694, filed on Feb. 22, 2022.

(51) Int. Cl. E04D 1/20; C08L 95/00; C08K 3/22; C08K 3/38; C08K 3/34

(52) U.S. Cl. CPC E04D 1/20; C08L 95/00; C08K 3/22; C08K 3/38; C08K 3/34; C08K 2003/2224; C08L 2555/50; C08L 2201/02; E04D 2001/005

(57) ABSTRACT

The present disclosure related generally to a bituminous composition suitable for use in roofing material, the bituminous composition a bituminous component comprising an asphalt component in an mount in the range of 75-95 wt% of the bituminous component, a rubber polymer in an amount of 5-20 wt% of the bituminous component, and a polyolefin wax in an amount up to 5 wt% of the bituminous component; and dispersed within the bituminous component, a filler component comprising at least one of both huntite and hydromagnesite; wollastonite; and both magnesium hydroxide and zinc borate, wherein the total amount of the huntite, hydromagnesite, wollastonite, magnesium hydroxide and zinc borate is in the range of 20-70 wt% of the bituminous component.

### CROSS-REFERENCE TO RELATED APPLICATIONS

This application claims the benefit of priority of U.S. Provisional Patent Application no. 63/312,694, filed February 22, 2023, which is hereby incorporated herein by reference in its entirety.

### BACKGROUND OF THE DISCLOSURE 1. Field of the Disclosure

The present disclosure relates generally to bituminous composition with improved fire-resistant performance suitable, for example, for use in roofing shingles, roofing membranes and roofing systems.

2. Technical Background

Bituminous-based roofing shingles and membranes, used particularly in low-slope roofing systems, are applied to roofing structures to provide long-lasting and satisfactory roof coverings. Such shingles and membranes also protect the roofing structure from weather, particularly rain and water intrusion. Additionally, bituminous-based roofing shingles and membranes must meet the demanding fire resistant requirements set forth by national and international codes.

The fire resistant properties of roofing products are commonly measured using Underwriters' Laboratories (UL) 790 Fire Tests of Roofing Coverings. Three tests are performed (intermittent-flame, burning-brand, and spread of flame) on a deck that includes the bituminous composition used in the desired roofing product. These tests provide a benchmark for three different classes of fire exposure: a Class A rating, wherein the roofing product is effective against severe fire test exposures, a Class B rating, wherein the roofing product is effective against moderate fire test exposures, and Class C rating, wherein the roofing product is effective against light fire test exposures. Ideally, roofing products have a Class A fire rating.

To improve the fire resistant performance of roofing products, fire retardants can be added directly to the bituminous compositions or the roofing products can be coated with compositions including fire retardant chemicals. However, balancing the necessary physical properties of the bituminous composition, such as viscosity, penetration depth, and softening point, with the desired fire resistant properties presents challenges, especially for low-slope roofing systems. Currently, there is a need for Class A rated roofing shingles and membranes for low-slope roofing systems.

Accordingly, the present inventors have determined that there is a need for improvements in bituminous compositions to provide fire-resistance to roofing products, such as shingles and membranes, especially for low-slop roofs.

SUMMARY OF THE DISCLOSURE

The present inventors have noted that current asphalt roofing products are not capable of providing desirably high fire ratings for low-slope roofs. One approach to improve the fire resistant performance of roofing products is to coat the roofing products with compositions including fire retardant chemicals. However, this approach option has limited longevity and merely provides surfaces with fire resistance. Another approach is to add fire retardants directly to the bituminous compositions. However, it is difficult to balance the relatively large amounts of fire retardants in the composition necessary to provide the fire resistant properties, while maintaining the desired physical properties of the composition, such as viscosity, penetration depth, and softening point. Accordingly, the present inventors have found a bituminous composition that includes fire retardants and can provide for roofing products having improved fire performance for low-slope roofs, while still providing desired physical properties.

Thus, in one aspect, the disclosure provides a bituminous composition suitable for use in roofing materials, the bituminous composition comprising:

a bituminous component comprising:

an asphalt component in an amount in the range of 75-95 wt% of the bituminous component; a rubber polymer in an amount of 5-20 wt% of the bituminous component; and a polyolefin wax in an amount up to 5 wt% of the bituminous component; and dispersed within the bituminous component, a filler component comprising at least one of both huntite and hydromagnesite; wollastonite; and both magnesium hydroxide and zinc borate, wherein a total amount of huntite, hydromagnesite, wollastonite, magnesium hydroxide and zinc borate is in the range of 20-70 wt% of the bituminous component.

In various particular aspects of the disclosure, huntite, hydromagnesite, and wollastonite are present in the bituminous composition. In other particular aspects of the disclosure, both huntite and hydromagnesite are present together with zinc borate in the bituminous composition. In other particular aspects of the disclosure, huntite, hydromagnesite and wollastonite together with zinc borate are present in the bituminous composition. In other particular aspects of the disclosure, magnesium hydroxide and zinc borate are present in the bituminous composition.

Another aspect of the disclosures provides a roofing shingle comprising the bituminous composition as described herein. Another aspect of the disclosure provides a roofing membrane comprising the bituminous composition as described herein. Yet another aspect of the disclosure provides a roofing system comprising a roof structure and the roofing shingle or the roofing membrane as described herein. Additional aspects of the disclosure will be evident from the disclosure herein.

### BRIEF DESCRIPTION OF THE FIGURES

The accompanying drawings are included to provide a further understanding of the methods and devices of the disclosure, and are incorporated in and constitute a part of this specification. The drawings are not necessarily to scale, and sizes of various elements may be distorted for clarity. The drawings illustrate one or more embodiment(s) of the disclosure, and together with the description serve to explain the principles and operation of the disclosure.

FIG. 1 is a bar graph of the average weight loss percent of roofing samples prepared with bituminous compositions as described herein.

FIG. 2 is a bar graph of the average burned percent of roofing samples prepared with bituminous compositions as described herein.

FIG. 3 is a bar graph of the average after flame time of roofing samples prepared with bituminous compositions as described herein.

FIG. 4 is a bar graph of the weight loss percent of individual trials for roofing samples prepared with bituminous compositions as described herein.

FIG. 5 is a bar graph of the burned percent of individual trials for roofing samples prepared with bituminous compositions as described herein.

FIG. 6 is a bar graph of the after flame time of individual trials for roofing samples prepared with bituminous compositions as described herein.

FIG. 7 is a collection of pictures of a deck prepared with a bituminous composition as described herein taken after the ASTM E108 test.

FIG. 8 is a collection of pictures of a deck prepared with a bituminous composition as described herein after the ASTM E108 test.

### DETAILED DESCRIPTION

As described above, the present inventors have noted that bituminous roofing shingles and membranes must meet strict fire resistance requirements based on the ASTM E108 tests. In particular, for low-slope roofing systems, there is a need to provide roofing shingles and membranes with a Class A rating. The present inventors have determined that the use of huntite, hydromagnesite, wollastonite, magnesium hydroxide, and/or zinc borate in the bituminous compositions can provide improved fire performance, in many cases even providing Class A rating to roofing systems with a 2:12 slope.

Accordingly, one aspect of the disclosure is a bituminous composition suitable for roofing materials, the bituminous composition comprising a bituminous component and dispersed within the bituminous component, a filler component. The bituminous component includes an asphalt component in an amount in the range of 75-95 wt% of the bituminous component, a rubber polymer in an amount of 5-20 wt% of the bituminous component, and optionally, polyolefin wax in an amount up to 5 wt% of the bituminous mixture. The filler component comprises at least one of a) both huntite and hydromagnesite; b) wollastonite; and c) both magnesium hydroxide and zinc borate, wherein the total amount of huntite hydromagnesite, wollastonite, magnesium hydroxide and zinc borate is in the range of 20-70 wt% of the bituminous component. The person of ordinary skill in the art will identify materials and adjust amounts in view of the disclosure herein.

As the person of ordinary skill in the art will appreciate, a wide variety of asphalt materials are available for use in a roofing shingle or membrane, and the type of asphalt material is not particularly limited. For example, the asphalt material can be selected from either oxidized or unoxidized asphalt. Typical “roofing flux” asphalts are oxidized in order to provide the hardness and resistance to penetration necessary for desirable performance. Such oxidation is typically performed by blowing air through the asphalt at high temperature in order to oxidize it. Non-oxidized asphalt is typically much softer and penetrable. As an example, unoxidized asphalt often has a softening point in the range of 90-100 ° F. and a penetration index on the order of 350-400 dmm, both measured according to ASTM 3462. In contrast, oxidized asphalts used in roofing applications typically have softening points of 200 ° F. and above, and penetrations of no more than 20 dmm.

The person of ordinary skill in the art will provide a type and amount of asphalt material that provides the bituminous composition and ultimately the roofing membrane with specific properties. Accordingly, in various embodiments of the disclosure as described herein, the asphalt component has a pen range lying above 100 pen. For example, in various embodiments, the asphalt component is a 150-200 pen asphalt. In various embodiments as otherwise described herein, the asphalt material is present in an amount in the range of 80-95 wt% of the bituminous component. For example, the asphalt material is present in an amount in the range of 85-95 wt%, or 90-95 wt%, or 75-90 wt%, or 80-90 wt%, or 85-90 wt%, or 75-85 wt%, or 80-85 wt%, or 75-80 wt% of the bituminous component. In particular embodiments of the disclosure, the asphalt component is present in an amount in the range of 87-91 wt% of the bituminous component.

As noted above, the bituminous composition also includes a rubber polymer, thus providing a so-called polymer-modified asphalt. A wide variety of rubber polymers are known for use in polymer-modification of asphalt. In various embodiments of the disclosure, the rubber polymer comprises one or more styrene block copolymers. In other embodiments of the disclosure, the rubber polymer is a styrene block copolymer. Examples of styrene block copolymers include styrene/butadiene/styrene block copolymers, styrene/isoprene/styrene block copolymers, styrene/ethylene/propylene/styrene block copolymers, styrene/ethylene/butadiene/styrene block copolymers, styrene/isoprene/butadiene/styrene block copolymers, styrene/isoprene/propylene/styrene block copolymers, and styrene/ethylene/ethylene-propylene/styrene block copolymers. The person of ordinary skill in the art can select a desired rubber polymer. In various desirable embodiments, the rubber polymer is a styrene/butadiene/styrene block copolymer.

The rubber polymer can be present in an amount in the range of 5-20 wt% of the bituminous component, as described above. For example, in various embodiments as otherwise described herein, the rubber polymer is present in an amount in the range 5-15 wt%, or 5-10 wt%, or 10-20 wt%, or 10-15 wt%, or 15-20 wt% of the bituminous component. In various embodiments as otherwise described herein, the rubber polymer is present in an amount of 7-14 wt% of the bituminous component.

As described above, the present inventors have noted that it can be challenging to include fire retardants in bituminous compositions, without sacrificing the physical properties of the bituminous composition, such as viscosity, penetration depth, and softening point. The present inventors have found that the inclusion of a polyolefin wax, for example, can help in dispersing the elastomeric polymer modifier in the asphalt and tune the rheological properties of the bituminous composition, even with large amounts of fire retardants present. Accordingly, in various embodiments as otherwise described herein, the bituminous composition includes a polyolefin wax in an amount of up to 5 wt% of the bituminous component. Polyethylene wax, polypropylene wax, and wax copolymers of ethylene and propylene can be useful as polyolefin waxes. In particular embodiments, the polyolefin wax comprises a polypropylene wax. In other embodiments, the polyolefin wax is a polypropylene wax. Virgin or recycled materials can be used. For example, in some embodiments as described herein, the polyolefin wax is a recycled polyolefin wax. In various embodiments, the polyolefin wax is present in an amount in the range 0.5-4 wt%, or 0.5-3 wt%, or 0.5-2 wt%, or 1-4 wt%, or 1-3 wt% of the bituminous component.

The bituminous component can also include any of a number of other additives. Such additives include, for example, sulfur, polyphosphoric acid (PPA), ferric chloride, waxes of animal or plant origin, plastomers, carbon black (e.g., in a thermoplastic carrier such as EVA) surfactants, antioxidants, oils and resins, and UV stabilizers (such as UV absorbers). The secondary additives may be included in any amount desired to achieve the desired asphalt properties, as is conventional in the art. Such additives can be present a variety of total amounts, e.g., up to 10 wt%, up to 5 wt%, or up to 2 wt% of the bituminous component. In various embodiments of the present disclosure, the bituminous component further includes an antioxidant. One example of such an antioxidant is carbon black. For example, in various embodiments of the disclosure as described herein, the antioxidant is present in the bituminous composition in an amount in the range of 0-5 wt% (e.g., in the range of 1-5 wt%, or 0.5-2.5 wt%).

The asphalt component, rubber polymer, polypropylene wax, and any other secondary additives (if present) comprise the non-fire retardant components of the bituminous component of the bituminous composition. In various desirable embodiments, the bituminous component is at least 50 wt% of the bituminous composition, e.g., at least 55 wt%, at least 60 wt%, or even at least 65 wt% of the bituminous composition. In various other embodiments, the bituminous component is at most 70 wt% of the bituminous composition, e.g., at most 65 wt%, at most 60 wt%, or even at most 55 wt% of the bituminous composition.

As described above, the present inventors have found that the use of huntite, hydromagnesite, wollastonite, magnesium hydroxide, and/or zinc borate as described can provide desirable fire resistance qualities to the bituminous composition as described herein. As such, in various embodiments of the disclosure, dispersed within the bituminous component is a filler component comprising at least one of a) both huntite and hydromagnesite; b) wollastonite; and c) both magnesium hydroxide and zinc borate, wherein the total amount of huntite, hydromagnesite, wollastonite, magnesium hydroxide, and/or zinc borate is in the range of 20-60 wt% of the bituminous component. For example, in various embodiments as described herein, the filler component includes a mixture of huntite and hydromagnesite. In other embodiments as described herein, the filler component includes wollastonite. In various other embodiments as described, the filler component includes both a mixture of huntite and hydromagnesite and wollastonite. In various other embodiments, the filler component includes a mixture of huntite and hydromagnesite, wollastonite, and zinc borate. In other embodiments, the filler component includes both magnesium hydroxide and zinc borate. Accordingly, in various embodiments of the disclosure, the total amount of the mixture of huntite and hydromagnesite, wollastonite, magnesium hydroxide, and zinc borate is in the range of 20-65 wt%, or 20-60 wt%, or 20-50 wt%, or 20-45 wt%, or 20-40 wt%, or 20-35 wt%, or 20-30 w%, or 25-60 wt%, or 25-50 wt%, or 25-45 wt%, or 25-40 wt%, or 25-35 wt%, or 30-60 wt%, or 30-50 wt%, or 30-45 wt%, or 30-40 wt%, or 35-60 wt%, or 35-55 wt%, or 35-50 wt%, or 35-40 wt%, or 40-60 wt%, or 40-55 wt%, or 40-50 wt%, or 45-60 wt%, or 45-55 wt%, or 50-60 wt% of the bituminous component.

In various embodiments of the disclosure as described herein, both huntite and hydromagnesite are present in the bituminous composition. The person of skill in the art will understand that the source(s) of huntite and hydromagnesite are not particularly limited and can be selected from any known source. For example, a mixture of huntite and hydromagnesite may be obtained from LKAB Minerals as sold under the trade name UltraCarb. In various embodiments as otherwise described herein, the huntite and hydromagnesite are present in a huntite:hydromagnesite ratio in the range of 1:4 or 4:1. For example, in various embodiments of the disclosure, the huntite:hydromagnesite ratio is in the range 2:3 to 3:2. In various particular embodiments of the disclosure as otherwise described herein, huntite and hydromagnesite are present in a huntite:hydromagnesite ratio of 30:70 to 50:50, e.g., about 2:3.

Accordingly, in various embodiments as otherwise described herein, the huntite and hydromagnesite are present in a total amount in the range of 10-70 wt% of the bituminous component. For example, in various embodiments, the huntite and hydromagnesite are present in a total amount in the range of 10-65 wt.%, or 10-60 wt%, or 10-55 wt%, or 10-50 wt%, or 10- 45 wt%, or 10-40 wt%, or 10-35 wt%, or 10-30 wt%, or 10-25 wt%, or 10-20 wt%, or 15-60 wt%, or 15-55 wt%, or 15-50 wt%, or 15-45 wt%, or 15-40 wt%, or 15-35 wt%, or 15-30 wt%, or 15-25 wt% of the bituminous component. In various other embodiments as described herein, the huntite and hydromagnesite are present in a total amount in the range of 20-70 wt%, e.g., in the range of 20-65 wt.%, or 20-60 wt%, or 20-55 wt%, or 20-50 wt%, or 20-45 wt%, or 20-40 wt%, or 20-35 wt%, or 20-30 wt%, or 25-60 wt%, or 25-55 wt%, or 25-50 wt%, or 25-45 wt%, or 25-40 wt%, or 25-35 wt% of the bituminous component. In various other embodiments, the huntite and hydromagnesite are present in a total amount in the range of 30-70 wt%, e.g., in the range of 30-65 wt.%, or 30-60 wt%, or 30-55 wt%, or 30-50 wt%, or 30-45 wt%, or 30-40 wt%, or 35- 60 wt%, or 35-55 wt%, or 35-50 wt%, or 35-45 wt% of the bituminous component. In various other embodiments as described herein, the huntite and hydromagnesite are present in a total amount in the range of 40-70 wt%, e.g., in the range of 40-65 wt.%, or 40-60 wt%, or 40-55 wt%, or 40-50 wt%, or 45-60 wt%, or 45-55 wt%, or 50-60 wt% of the bituminous component. The amounts of huntite and hydromagnesite will be calculated taking into account the actual huntite/hydromagnesite content of a source(s) thereof (i.e., by using the purity of the source(s)).

As described above, in various embodiments of the disclosure, wollastonite is present in the bituminous composition. Wollastonite can be, for example, provided together with huntite and hydromagnesite, or together with huntite, hydromagnesite and zinc borate. In other embodiments, wollastonite is provided in the absence of huntite, hydromagnesite and zinc borate.

In various embodiments, the wollastonite is present in an amount in the range of 10- 70 wt% of the bituminous component. For example, the wollastonite can be present in an amount in the range of 10-65 wt.%, or 10-60 wt%, or 10-55 wt%, or 10-50 wt%, or 10-45 wt%, or 10-40 wt%, or 10-35 wt%, or 10-30 wt%, or 10-25 wt%, or 10-20 wt%, or 15-60 wt%, or 15-55 wt%, or 15-50 wt%, or 15-45 wt%, or 15-40 wt%, or 15-35 wt%, or 15-30 wt%, or 15-25 wt% of the bituminous component. In other embodiments, the wollastonite is present in an amount in the range of 20-70 wt%, e.g., 20-65 wt.%, or 20-60 wt%, or 20-55 wt%, or 20-50 wt%, or 20-45 wt%, or 20-40 wt%, or 20-35 wt%, or 20-30 wt%, or 25-60 wt%, or 25-55 wt%, or 25-50 wt%, or 25-45 wt%, or 25-40 wt%, or 25-35 wt% of the bituminous component. In various other embodiments, the wollastonite is present in an amount in the range of 30-70 wt%, e.g., 30-65 wt.%, or 30-60 wt%, or 30-55 wt%, or 30-50 wt%, or 30-45 wt%, or 30-40 wt%, or 35-60 wt%, or 35-55 wt%, or 35-50 wt%, or 35-45 wt% of the bituminous component. In various embodiments as otherwise described herein, the wollastonite is present in an amount in the range of 40-70 wt%, e.g., 40-65 wt.%, or 40-60 wt%, or 40-55 wt%, or 40-50 wt%, or 45-60 wt%, or 45-55 wt%, or 50-60 wt% of the bituminous component. The person of skill in the art will understand that the source of wollastonite is not particularly limited and can be selected from any known source. The amounts of wollastonite will be calculated taking into account the actual wollastonite content of a wollastonite source (i.e., by using the purity of the source).

In various embodiments in which one or more other of the zinc borate, magnesium hydroxide, huntite and hydromagnesite components are present, relatively less wollastonite may be present. For example, in various embodiments as otherwise described herein, e.g., when huntite and hydromagnesite are present (with or without zinc borate), the wollastonite is present in an amount up to 20 wt%, e.g., up to 15%, or up to 10%, for example, in the range of 5-20 wt%, or 5-15 wt%, or 1-10 wt%.

As described above, in various embodiments of the disclosure, magnesium hydroxide and zinc borate are present in the bituminous composition. In various embodiments, the magnesium hydroxide is present in an amount in the range of 10-70 wt% of the bituminous component. For example, the magnesium hydroxide can be present in an amount in the range of 10-65 wt.%, or 10-60 wt%, or 10-55 wt%, or 10-50 wt%, or 10-45 wt%, or 10-40 wt%, or 10- 35 wt%, or 10-30 wt%, or 10-25 wt%, or 10-20 wt%, or 15-60 wt%, or 15-55 wt%, or 15-50 wt%, or 15-45 wt%, or 15-40 wt%, or 15-35 wt%, or 15-30 wt%, or 15-25 wt% of the bituminous component. In other embodiments, the magnesium hydroxide is present in an amount in the range of 20-70 wt%, e.g., 20-65 wt.%, or 20-60 wt%, or 20-55 wt%, or 20-50 wt%, or 20-45 wt%, or 20-40 wt%, or 20-35 wt%, or 20-30 wt%, or 25-60 wt%, or 25-55 wt%, or 25-50 wt%, or 25-45 wt%, or 25-40 wt%, or 25-35 wt% of the bituminous component. In various other embodiments, the magnesium hydroxide is present in an amount in the range of 30-70 wt%, e.g., 30-65 wt.%, or 30-60 wt%, or 30-55 wt%, or 30-50 wt%, or 30-45 wt%, or 30-40 wt%, or 35-60 wt%, or 35-55 wt%, or 35-50 wt%, or 35-45 wt% of the bituminous component. In various embodiments as otherwise described herein, the magnesium hydroxide is present in an amount in the range of 40-70 wt%, e.g., 40-65 wt.%, or 40-60 wt%, or 40-55 wt%, or 40-50 wt%, or 45- 60 wt%, or 45-55 wt%, or 50-60 wt% of the bituminous component. The person of skill in the art will understand that the source of magnesium hydroxide is not particularly limited and can be selected from any known source. The amount of magnesium hydroxide will be calculated taking into account the actual magnesium hydroxide content of a magnesium hydroxide source (i.e., by using the purity of the source).

As noted above, in various embodiments of the disclosure, zinc borate is present in the bituminous composition. For example, zinc borate can be provided together with magnesium hydroxide as described above. Zinc borate can also be provided together with huntite and hydromagnesite, with wollastonite, or with huntite, hydromagnesite, and wollastonite.

If present, the zinc borate is present in an amount in an amount up to 20 wt% (e.g., up to 15 wt% or up to 10 wt%) of the bituminous component, e.g., in the range of 1-20 wt% of the bituminous component. For example, in various embodiments, the zinc borate is present in an amount in the range of 1-15 wt%, or 1-10 wt%, or 1-5 wt%, or 2-20 wt%, or 2-15 wt%, or 2- 10 wt%, or 5-20 wt%, or 5-15 wt%, or 10-20 wt% of the bituminous component. The amount of zinc borate will be calculated taking into account the actual zinc borate content of a zinc borate source (i.e., by using the purity of the source).

In various embodiments, the total amount of huntite, hydromagnesite, wollastonite, magnesium hydroxide and zinc borate is at least 35 wt% of the bituminous component, e.g., at least 40 wt%, at least 45 wt%, or even at least 50 wt% of the bituminous component. In various other embodiments, the total amount of huntite, hydromagnesite, wollastonite, magnesium hydroxide and zinc borate is at most 60 wt% of the bituminous component, e.g., at most 55 wt%, at most 50 wt%, or even at most 45 wt%.

The combination of components of the bituminous composition described herein can provide the materials with desirable physical properties, despite including a high amount of fire retardant materials (e.g., huntite, hydromagnesite wollastonite, magnesium hydroxide, and/or zinc borate). For example, in various embodiments as otherwise described herein, the bituminous composition has a viscosity at 375° F. in the range of 3500 to 8000 cP. In various embodiments the bituminous composition has a viscosity at 375° F. in the range of 4000 to 8000 cP, or 4500 to 8000 cP, or 5000 to 8000 cP, or 3500 to 7500 cP, or 4000 to 7500 cP, or 4500 to 7500 cP, or 5000 to 7500 cP, or 3500 to 7000 cP, or 4000 to 7000 cP, or 4500 to 7000 cP, or 5000 to 7000 cP. Viscosities are measured using a rotational viscometer, such as an AMETEK Brookfield viscometer.

The bituminous composition as described herein can have any desirable penetration index (i.e., the depth to which a probe will penetrate under specified conditions) as required for the final roofing product. In various embodiments as otherwise described herein, the bituminous composition has a penetration index at 77° F. of no more than 70 dmm, (e.g., no more than 60 dmm, or no more than 50 dmm). In various embodiments, the bituminous composition penetration index at 77° F. of at least 20 dmm (e.g., at least 30 dmm, or at least 40 dmm). For example, in various embodiments, the bituminous composition has a penetration index at 77° F. in the range of 20-70 dmm, e.g., 30-70 dmm, or 40-70 dmm, or 20-60 dmm, or 30-60 dmm, or 40-60 dmm, or 20-50 dmm, or 30-50 dmm, or 40-50 dmm. Penetration index is measured according to ASTM D5M.

In various embodiments, the bituminous composition has a penetration index at 32° F. of no more than 30 dmm (e.g., no more than 25 dmm, or no more than 20 dmm). In various embodiments, the bituminous composition has a penetration index at 32° F. of at least 5 dmm (e.g., of at least 10 dmm, or at least 15 dmm). In various embodiments, the bituminous composition has a penetration index at 115° F. or no more than 70 dmm (e.g., no more than 60 dmm, or 50 dmm). In various embodiments, the bituminous composition has a penetration index at 115° F. of at least 20 dmm (e.g. at least 30 dmm, or at least 30 dmm). Penetration index is measured according to ASTM DSM.

Additionally, the bituminous composition herein can have any desirable softening point as required for the final roofing product. In various embodiments, the bituminous composition has a softening point of at least 200 ° F., e.g., at least 225 ° F., or at least 250 ° F., as measured according to ASTM D36M. In various embodiments, the bituminous composition has a no more than 320 ° F., e.g., no more than 310 ° F., or no more than 300 ° F., or no more than 290° F., as measured according to ASTM D36M. For example, in various embodiments, the softening point of the bituminous composition is in the range of 200-320 ° F., e.g., 225-320 ° F., or 250-320 ° F., or 200-310 ° F., or 225-310 ° F., or 250-310 ° F., or 200-300 ° F., or 225-300 ° F., or 250- 300 ° F., 200-290 ° F., or 225-290 ° F., or 250-290 ° F.

As noted above, the bituminous composition is particularly suitable for use in roofing shingles. Accordingly, another aspect of the present disclosure is a roofing shingle comprising a porous substrate, at least one layer of the bituminous composition as described herein having a top surface and disposed on the porous substrate, and a plurality of granules disposed upon the top surface of the at least one layer of the bituminous composition. In particular examples, the roofing shingle has a Class A fire rating under ASTM E108, e.g., with at least a 0.5:12 slope (e.g., at least a 1:12 or 2:12 slope). For example, the roofing shingle may have a class A rating under ASTM E108 ata slope in the range of 0.5:12 to 5:12.

These shingles can be made by any means as known in the art. For example, in various embodiments as otherwise described herein, the porous substrate has a top surface and a bottom surface, having the bituminous composition as described herein disposed thereon. As the person of ordinary skill in the art will appreciate, the bituminous composition can be coated on both surfaces of, or even saturate, the porous substrate. A variety of materials can be used as the porous substrate, for example, conventional bituminous shingle or membrane substrates such as roofing felt or fiberglass. The bituminous composition also has a top surface. A plurality of roofing granules is adhered on the top surface of the shingle (e.g., the top surface of the bituminous composition), such that the roofing granules substantially coat the bituminous composition in a region thereof. The region can be, for example, the exposure zone of a roofing shingle, or a region that is otherwise to be exposed when the roofing product is installed on a roof. The roofing granules are desirably embedded somewhat in the bituminous composition to provide for a high degree of adhesion. As the person of ordinary skill in the art will appreciate, other granular or particulate material can coat the bituminous composition in regions that will not be exposed, e.g., on a bottom surface of the roofing shingle, or in a headlap zone of a top surface of the roofing shingle, as is conventional. The plurality of roofing granules is not particularly limited and can be selected from any roofing granules known to those in the art. For example, the plurality of roofing granules may include water-resistant roofing granules, algae-resistant roofing granules, or solar reflective roofing granules.

For use in roofing shingles, asphalt materials are typically filled with a particulate or fibrous filler. Accordingly, another aspect of the disclosure is a bituminous composition further comprising a reinforcing material as described herein. The reinforcing material can be a particulate filler and/or a fibrous filler. Suitable particulate fillers include mineral fillers like calcium carbonate (e.g., in the form of limestone), calcium magnesium carbonate (e.g., in the form of dolomite), and calcium sulfate (e.g., in the form of gypsum). Materials like fly ash, ceramic, carbon, glass (in particulate or fiber form), recycled tire material, and plastic waste can also be used. In various embodiments, the bituminous composition is present in an amount in the range of 25-75 wt% and the reinforcing material is present in an amount in the range of 25- 75 wt%, but the person of ordinary skill in the art will appreciate that different relative amounts can be used.

As noted above, the bituminous composition is particularly suitable for roofing membranes. These membranes can be made by any means as known in the art. Accordingly, another aspect of the disclosure is a roofing membrane comprising the bituminous composition as described herein, disposed on at least one side of, or within, a porous substrate. For example, in various embodiments, the porous substrate has a top side and a bottom side, wherein the bituminous composition as described herein is disposed on the top side of the porous substrate, or the bottom of the porous substrate, or both. In particular embodiments, the bituminous composition as described herein is disposed on the top side of the porous substrate.

A variety of porous substrates can be used for the roofing membrane. For example, in various embodiments the porous substrate is a fibrous mat, for example, formed from woven or non-woven glass fibers, polymeric fibers, or a combination of glass and polymeric fibers, e.g., a fiberglass sheet or a roofing felt. The top and bottom bituminous layers can be made from the same material as one another, or from different materials, with at least the top layer being a bituminous composition as described herein. In particular examples, the roofing membrane has a Class A fire rating under ASTM E108, e.g., with at least a 0.5:12 slope (e.g., at least 1:12 or 2:12 slope). For example, the roofing membrane may have a class A rating under ASTM E108 at a lope in the range of 0.5:12 to 2:12.

Another aspect of the disclosure provides a roofing system comprising the roofing shingles or roofing membrane as described herein. For example, in various embodiments the roofing system comprises a roof structure and a roofing shingle as described herein or a roofing membrane as described herein. In particular examples, the roofing system is a low-slope roofing system. For example, in various embodiments, the roofing system as described herein has a slope in the range of 0.25:12 - 12:12 (e.g., in the range of 0.5:12 to 6:12, or 0.5:12 to 5:12, or 0.5:12 to 4:12, or 0.5:12 to 3:12, or 1:12 to 12:12, or 1:12 to 6:12, or 1:12 to 5:12, or 1:12 to 4:12, or 1:12 to 3:12, or 2:12 to 12:12, or 2:12 to 6:12, or 2:12 to 5:12, or 2:12 to 4:12, or 2:12 to 3:12). For example, in some embodiment wherein the roofing system includes a roofing shingle as described herein, the roofing system has a slope in the range of 2:12 to 12:12. In other examples, wherein the roofing system includes a roofing membrane as described herein, the roofing system has a slope in the range of 0.25:12 to 5:12.

EXAMPLES

The Examples that follow are illustrative of specific embodiments of the process of the disclosure, and various uses thereof. They are set forth for explanatory purposes only, and are not to be taken as limiting the scope of the disclosure.

Example 1. Small Scale Bituminous Compositions

A variety of bituminous formulations were prepared on a laboratory scale. For the asphalt material of the bituminous formulations, Philips 66 15-200 pen asphalt was used. Dynasol Solprene 411, a 70/30 butadiene/styrene thermoplastic copolymer was used as the rubber polymer, and GreenMantra Ceranovus 155, a polypropylene wax, was used as the polyolefin wax. The formulations also included fire-resistant materials selected from magnesium hydroxide, zine borate, UltraCarb LH15 (a mixture of huntite and hydromagnesite), and wollastonite. The formulations prepared are described in Table 1.

TABLE 1

| | Phillips 66 | | | | | | | |
|---|---|---|---|---|---|---|---|---|
| | 150-200 | Dynasol | Ceranovus | Magnesium | Zinc | UltraCarb | | Filler |
| # | pen asphalt | 411 | 155 | Hydroxide | Borate | LH15 | Wollastonite | Total |
| 1 | 89 | 11 | | 25 | 5 | | | 30 |
| 2 | 89 | 11 | | | | 20 | 10 | 30 |
| 3 | 89 | 9.5 | 1.5 | 30 | 10 | | | 40 |
| 4 | 89 | 9.5 | 1.5 | | | 25 | 15 | 40 |
| 5 | 89 | 11 | | | 5 | 25 | | 30 |
| 6 | 89 | 9.5 | 1.5 | | 10 | 30 | | 40 |
| 7 | 89 | 9.5 | 1.5 | | 7.5 | 27.5 | | 35 |
| 8 | 89 | 9.5 | 1.5 | | | 30 | 15 | 45 |
| 9 | 89 | 9.5 | 1.5 | | | 30 | 10 | 40 |
| 10 | 89 | 9.5 | 1.5 | 35 | 5 | | | 40 |
| 11 | 89 | 9.5 | 1.5 | 30 | 10 | | | 40 |
| 12 | 89 | 9.5 | 1.5 | | | 25 | 15 | 40 |
| 13 | 89 | 9.5 | 1.5 | 25 | 15 | | | 40 |
| 14 | 89 | 9.5 | 1.5 | | 5 | 25 | 10 | 40 |
| 15 | 89 | 9.5 | 1.5 | | 2.5 | 25 | 15 | 42.5 |

Various formulations were tested for their physical properties, including viscosity, penetration depth, softening point, and staining. Their physical properties are reported in Table 2.

TABLE 2

| | # | | | | | | | | | |
|---|---|---|---|---|---|---|---|---|---|---|
| | 1 | 2 | 3 | 4 | 5 | 6 | 7 | 8 | 9 | 10 |
| Viscosity @375° F | 6625 | 5125 | 7438 | 5125 | 6875 | 8875 | 6875 | 8250 | 7375 | 9563 |
| (UNITS) | | | | | | | | | | |
| Penetration depth | 22 | 25 | 19 | 17 | 19 | 15 | 17 | 14 | 15 | 15 |
| at 32° F (dmm) | | | | | | | | | | |
| Penetration depth | 34 | 33 | 30 | 28 | 31 | 26 | 27 | 24 | 28 | 27 |
| at 77° F (dmm) | | | | | | | | | | |
| Penetration depth | 58 | 48 | 50 | 39 | 46 | 36 | 38 | 35 | 37 | 44 |
| at 115° F (dmm) | | | | | | | | | | |
| Softening Point (° F) | 255 | 262 | 265 | 267 | 260 | 272 | 266 | 274 | 271 | 273 |
| Stain (mm) | 0 | 0 | 0 | 0.5 | 0 | 0 | 0.5 | 0 | 0 | 0 |

The stain test was performed by placing a dollop of the formulation approximately 0.1 inches thick and 3 inches in diameter on a piece of filter paper (#50 Whatman Filter Paper, 185 mm diameter) and placing in an oven at 70° C. for 3 days. The reported value is the measured distance of leach from the asphalt into the paper, as a lateral distance away from the edge of the asphalt dollop to the edge of leach. This measures the propensity for leaching from asphalt onto roofing granules.

Example 2. Small Scale Fire Test

The formulations prepared in Example 1 were then evaluated for their fire-resistant properties, namely the percent weight loss, the percentage burned, and the after flame time, using a small scale fire test. Prior to testing, the formulations of Example 1 where first used to assemble a membrane cap sheet sample by coating a glass mat with the bituminous formulation, and coating roofing granules onto the bituminous formulation. The membrane sap sheet sample was cut to provide shinglet samples that were approximately 4″ wide to 6″ long. The shinglet samples (FR1 made using Formulation 1, FR2 made using Formulation 2, etc.) were then weighed to the nearest 0.01 grams.

To conduct the small scale fire test, the sample was placed on a metal structure that holds up to 4″ wide by 24″ long samples at an angle of 28° from horizontal with a wire mesh under the sample. A Humboldt burner with 40mm diameter, 10mm thick grid, and 8.5 inch high flame was then placed 1.5″ below the sample. The sample was centered with the burner's diameter. The burner was lit using a spark ignitor and kept on the sample for 2 minutes. The burner used 100% methane gas at a flow rate of 140 mL/min, and the oxygen was adjusted to keep the flame as blue as possible.

The flame was then turned off and the sample was timed for self-extinguishment (i.e. the after burn time). The sample was then weighed again and the longest length of the burned area was measured. The percent weight loss percentage was then calculated based on the weight difference of the sample before and after the small scale fire test. The burned percent was then calculated based on the ratio of the longest length of the burned area and the total length of the sample.

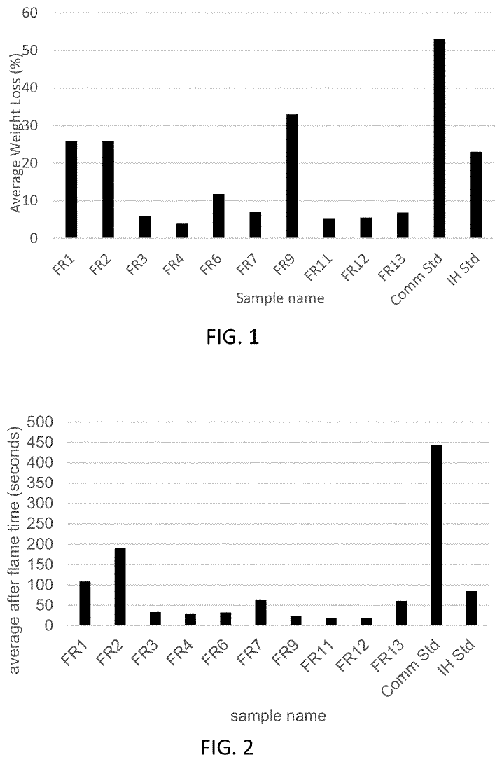

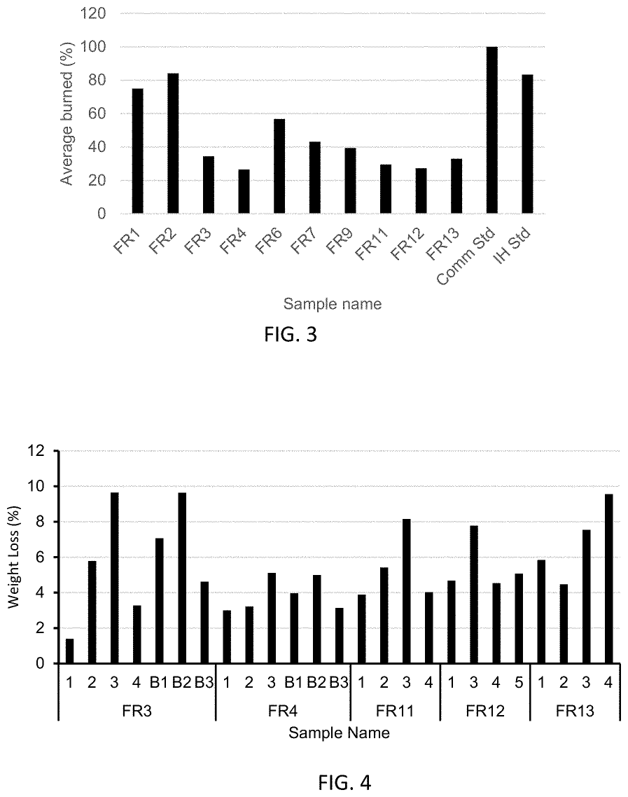

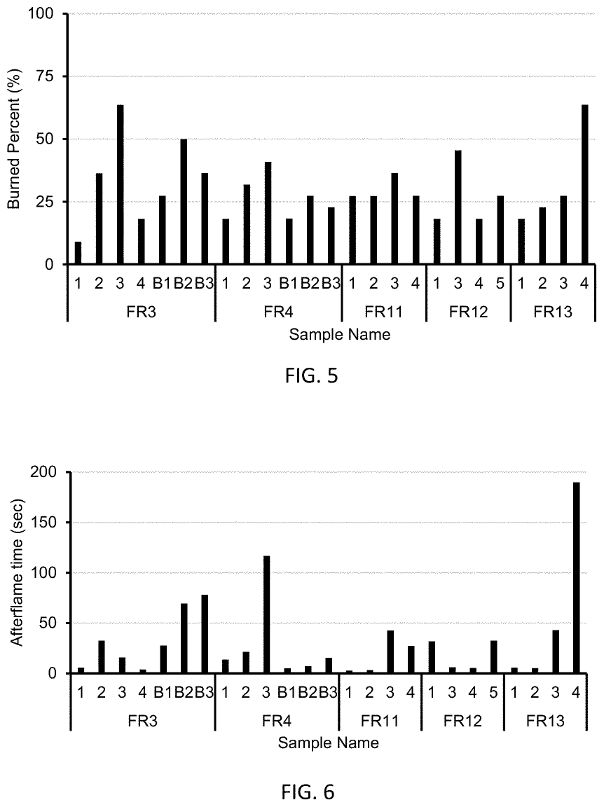

Roofing shingle samples FR1-FR4, FR6, FR7, FR9, and FR11-FR13 were evaluated using the small scale fire test. A commercially-available product and an in-house standard were also used as controls. Each sample was measured in multiple trials and an average percent weight loss, average percentage burned, and average after flame time was calculated for each of the formulations. These results are shown in Table 3 and depicted graphically in FIGS. 1-3. The results of the individual trails are shown in Table 4, and the results of individual trails for samples FR3, FR4 and FR11-13 are depicted graphically in FIGS. 4-6.

TABLE 3

| | Average | | Average | | Average | |
|---|---|---|---|---|---|---|
| | weight | Std. | After Flame | Std. | Burned | Std. |
| | loss (%) | Dev. | Time (sec) | Dev. | (%) | Dev. |
| FR1 | 26 | 18 | 109 | 47 | 75 | 28 |
| FR2 | 26 | 13 | 190 | 97 | 84 | 28 |
| FR3 | 6 | 3 | 33 | 27 | 34 | 17 |
| FR4 | 4 | 1 | 30 | 39 | 27 | 8 |
| FR6 | 12 | 4 | 33 | 17 | 57 | 11 |
| FR7 | 7 | 1 | 64 | 4 | 43 | 2 |
| FR9 | 33 | 2 | 25 | 26 | 39 | 9 |
| FR11 | 5 | 2 | 19 | 17 | 30 | 4 |
| FR12 | 6 | 1 | 19 | 13 | 27 | 11 |
| FR13 | 7 | 2 | 61 | 76 | 33 | 18 |
| Comm prod | 53 | 13 | 444 | 6 | 100 | 0 |
| IH std | 23 | 3 | 85 | 3 | 83 | 8 |

TABLE 4

| Formulation | Trial | Weight | After Flame | Burned |
|---|---|---|---|---|
| No. | No. | loss (%) | Time (sec) | (%) |
| FR1 | 1 | 19.8 | 98.72 | 81.8 |
| | 2 | 53.3 | 175.31 | 100.0 |
| | 3 | 4.2 | 43.34 | 27.3 |
| | 4 | 25.9 | 116.75 | 90.9 |
| FR2 | 1 | 39.0 | 308.56 | 100.0 |
| | 2 | 4.9 | 38.28 | 36.4 |
| | 3 | 30.9 | 215.75 | 100.0 |
| | 4 | 29.0 | 198.35 | 100.0 |
| FR3 | 1 | 1.4 | 5.72 | 9.1 |
| | 2 | 5.8 | 32.54 | 36.4 |
| | 3 | 9.6 | 15.84 | 63.6 |
| | 4 | 3.3 | 3.85 | 18.2 |
| | B1 | 7.1 | 27.62 | 27.3 |
| | B2 | 9.6 | 69.47 | 50.0 |
| | B3 | 4.6 | 78.23 | 36.4 |
| FR4 | 1 | 3.0 | 13.65 | 18.2 |
| | 2 | 3.2 | 21.41 | 31.8 |
| | 3 | 5.1 | 116.75 | 40.9 |
| | B1 | 4.0 | 5 | 18.2 |
| | B2 | 5.0 | 7.28 | 27.3 |
| | B3 | 3.1 | 15.44 | 22.7 |
| FR6 | 1 | 7.6 | 15.94 | 45.5 |
| | 2 | 15.9 | 49.39 | 68.2 |
| FR7 | 1 | 8.3 | 68.66 | 45.5 |
| | 2 | 5.9 | 60.25 | 40.9 |
| FR9 | 1 | 9.1 | 61.6 | 45.5 |
| | 2 | 4.7 | 5.44 | 45.5 |
| | 3 | 4.8 | 6.88 | 27.3 |
| FR11 | 1 | 3.9 | 2.79 | 27.3 |
| | 2 | 5.4 | 3.22 | 27.3 |
| | 3 | 8.2 | 42.72 | 36.4 |
| | 4 | 4.0 | 27.41 | 27.3 |
| FR12 | 1 | 4.7 | 31.88 | 18.2 |
| | 3 | 7.8 | 6.03 | 45.5 |
| | 4 | 4.5 | 5.43 | 18.2 |
| | 5 | 5.1 | 32.44 | 27.3 |
| FR13 | 1 | 5.8 | 5.68 | 18.2 |
| | 2 | 4.5 | 5.25 | 22.7 |
| | 3 | 7.5 | 42.91 | 27.3 |
| | 4 | 9.6 | 189.78 | 63.6 |
| Comm prod | 1 | 40.0 | 437.69 | 100.0 |
| | 2 | 66.1 | 450.5 | 100.0 |
| IH std | 1 | 20.1 | 88.32 | 75.0 |
| | 2 | 25.9 | 81.43 | 91.7 |

In the FR3 and FR4 samples, entries beginning with “B” denote samples made from a second batch of the formulation, for the purpose of understanding batch-to-batch variability.

Samples FR4 and FR12 exhibited the best performance over all three measurements when compared to any other formulation tested. In particular, sample FR4 exhibited the lowest average weight loss percentage and sample FR12 has the lowest average after flame time value. Further, both FR4 and FR12 exhibited the lowest average burned percentage of the samples tested.

Example 3. Large Scale Fire Test

For large scale fire testing, two samples were prepared by applying membrane cap sheet samples to a nailbase base sheet attached thereon to a plywood substrate to create a deck. Sample 1 used Formulation 4 coated on the top side of a fiberglass mat, with roofing granules coated onto the top bituminous coating. Sample 2 used a formulation similar to Formulation 12 but replacing 5% of the wollastonite with zinc borate, coated on the top side of a fiberglass mat, with roofing granules coated onto the top bituminous coating. In both samples, the bottom side was coated with a formulation including relatively less LH-15 and Wollastonite, as shown in Table 5 below.

TABLE 5

| | | | | wt |
|---|---|---|---|---|
| | | | Bituminous | % |
| Sample | Top/Bottom | | Component | of |
| No. | Formulations | Component | wt % | mix |
| 1 | Top | Phillips 66 150-200 pen | 87.75 | 52.65 |
| | | asphalt | | |
| | | Dynasol 411 SBS | 9.50 | 5.70 |
| | | Ceranovus 155 | 1.50 | 0.90 |
| | | MB 950 | 1.25 | 0.75 |
| | | Ultra-Carb LH15 | — | 25.00 |
| | | Wollastonite | — | 15.00 |
| | Bottom | Phillips 66 150-200 pen | 87.75 | 52.65 |
| | | asphalt | | |
| | | Dynasol 411 SBS | 9.50 | 5.70 |
| | | Ceranovus 155 | 1.50 | 0.90 |
| | | MB 950 | 1.25 | 0.75 |
| | | Ultra-Carb LH15 | — | 12.50 |
| | | Wollastonite | — | 7.50 |
| 2 | Top | Phillips 66 150-200 pen | 87.75 | 52.65 |
| | | asphalt | | |
| | | Dynasol 411 SBS | 9.50 | 5.70 |
| | | Ceranovus 155 | 1.50 | 0.90 |
| | | MB 950 | 1.25 | 0.75 |
| | | Ultra-Carb LH15 | — | 25.00 |
| | | Wollastonite | — | 10.00 |
| | | Zinc Borate | | 5.00 |
| | Bottom | Phillips 66 150-200 pen | 87.75 | 52.65 |
| | | asphalt | | |
| | | Dynasol 411 SBS | 9.50 | 5.70 |
| | | Ceranovus 155 | 1.50 | 0.90 |
| | | MB 950 | 1.25 | 0.75 |
| | | Ultra-Carb LH15 | — | 12.50 |
| | | Wollastonite | — | 7.50 |

*MB 950 is a 50% carbon black in a polyethylene vinyl acetate as a carrier resin.

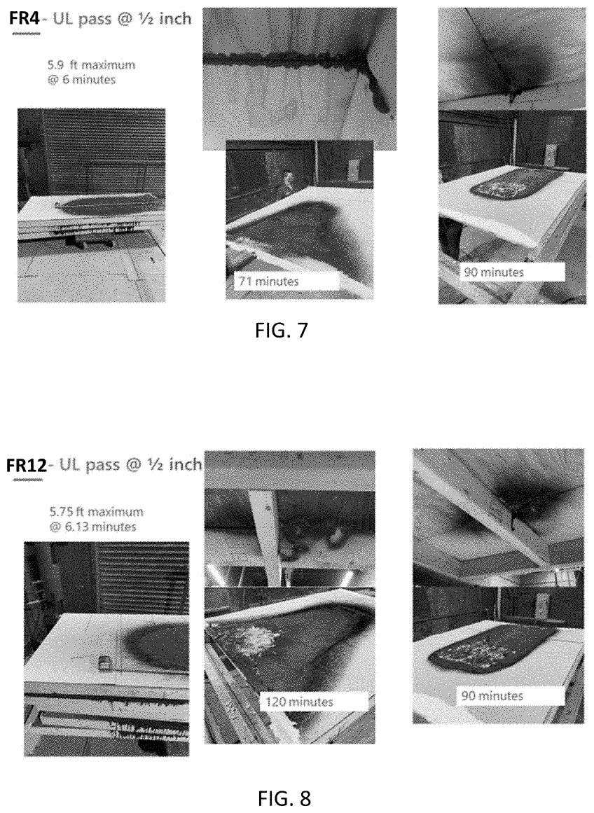

The samples were then tested under ASTM E108 conditions necessary to achieve a class A rating for a roof with a 0.5:12 slope. Specifically, the hot and cold tensile strength, tear strength, cold flex, compound stability, and adhesion to plywood were measured for each sample according to ASTM D6163. The results of for sample 1 are shown in Table 6 and FIG. 7 and the results for sample 2 are shown in Table 7 and FIG. 8.

TABLE 6
Sample 1

| Test | | SPEC | Value |
|---|---|---|---|
| 77° F. Tensile (lbs.) | MD | 44 min | 81.03 |
| | CD | 44 min | 56.06 |
| cold Tensile (lbs.) | MD | 44 min | 183.68 |
| | CD | 44 min | 122.82 |
| 77° F. Tear Strength (lbf) | MD | 20 min | 125.44 |
| | CD | 20 min | 91.61 |
| −20° F. Cold Flex | MD | Pass | pass |
| | CD | Pass | pass |
| compound stability at 215° | | pass | pass |
| | | pass | pass |
| Adhesion to Plywood (lb./ft) | | 12 min | 41.1 |

TABLE 7
Sample 2

| Test | | SPEC | Value |
|---|---|---|---|
| 77° F. Tensile (lbs.) | MD | 44 min | 96.42 |
| | CD | 44 min | 53.52 |
| cold Tensile (lbs.) | MD | 44 min | 132.62 |
| | CD | 44 min | 119.45 |
| 77° F. Tear Strength (lbf) | MD | 20 min | 116.42 |
| | CD | 20 min | 91.77 |
| −20° F. Cold Flex | MD | Pass | fail |
| | CD | Pass | fail |
| compound stability at 215° | | pass | pass |
| | | pass | pass |
| Adhesion to Plywood (lb./ft) | | 12 min | 13.82 |

Both samples 1 and 2 achieved a class A rating as measured under ASTM E108.

Additional aspects of the disclosure are provided by the following enumerated embodiments, which can be combined and permuted in any number and in any combination that is not technically or logically inconsistent.

Embodiment 1. A bituminous composition suitable for use in roofing materials, the bituminous composition comprising a bituminous component comprising:

an asphalt component in an amount in the range of 75-95 wt% of the bituminous component; a rubber polymer in an amount of 5-20 wt% of the bituminous component; and a polyolefin wax in an amount up to 5 wt% of the bituminous component; and dispersed within the bituminous component, a filler component comprising at least one of both huntite and hydromagnesite; wollastonite; and both magnesium hydroxide and zinc borate, wherein a total amount of huntite, hydromagnesite, wollastonite, magnesium hydroxide and zinc borate is in the range of 20-70 wt% of the bituminous component.

Embodiment 2. The bituminous composition according to embodiment 1, wherein the asphalt component has a pen range lying above 100 pen.

Embodiment 3. The bituminous composition according to embodiment 1, wherein the asphalt component is a 150-200 pen asphalt.

Embodiment 4. The bituminous composition according to any of embodiments 1-3, wherein the asphalt component is present in an amount in the range of 80-95 wt%, or 85-95 wt%, or 90-95 wt%, or 75-90 wt%, or 80-90 wt%, or 85-90 wt%, or 75-85 wt%, or 80-85 wt%, or 75-80 wt% of the bituminous component.

Embodiment 5. The bituminous composition according to any of embodiments 1-3, wherein the asphalt component is present in an amount in the range of 87-91 wt%.

Embodiment 6. The bituminous composition according to any of embodiments 1-5, wherein the rubber polymer comprises (or is) one or more styrene block copolymers.

Embodiment 7. The bituminous composition according to any of embodiments 1-5, wherein the rubber polymer comprises (or is) one or more styrene block copolymers selected from styrene/butadiene/styrene block copolymers, styrene/isoprene/styrene block copolymers, styrene/ethylene/propylene/styrene block copolymers, styrene/ethylene/butadiene/styrene block copolymers, styrene/isoprene/butadiene/styrene block copolymers, styrene/isoprene/propylene/styrene block copolymers, and styrene/ethylene/ethylene- propylene/styrene block copolymers.

Embodiment 8. The bituminous composition according to any of embodiments 1-5, wherein the rubber polymer is a styrene/butadiene/styrene block copolymer.

Embodiment 9. The bituminous composition according to any of embodiments 1-8, wherein the rubber polymer is present in an amount in the range of 5-15 wt%, or 5-10 wt%, or 10-20 wt%, or 10-15 wt%, or 15-20 wt% of the bituminous component.

Embodiment 10. The bituminous composition according to any of embodiments 1-8, wherein the rubber polymer is present in an amount of 7-14 wt% of the bituminous component.

Embodiment 11. The bituminous composition according to any of embodiments 1-10, wherein the polyolefin wax is a polyethylene wax, a polypropylene wax, or a wax copolymer of ethylene and propylene.

Embodiment 12. The bituminous composition according to any of embodiments 1-10, wherein the polyolefin wax comprises (or is) a polypropylene wax.

Embodiment 13. The bituminous composition according to any of embodiments 1-12, wherein the polyolefin wax is a recycled polyolefin wax.

Embodiment 14. The bituminous composition according to any of embodiments 1-13, wherein the polyolefin wax is present in an amount in the range of 0.5-4 wt%, or 0.5-3 wt%, or 0.5-2 wt%, or 1-4 wt%, or 1-3 wt% of the bituminous component.

Embodiment 15. The bituminous composition according to any of embodiments 1-14, wherein the bituminous component further comprises an antioxidant.

Embodiment 16. The bituminous composition according to any of embodiments 1-15, wherein an antioxidant is present in an amount in the range or 0-5 wt% (e.g., in the range of 1-5 wt%, or 0.5-2.5 wt%) of the bituminous component.

Embodiment 17. The bituminous composition according to any of embodiments 1-16, wherein the total amount of the huntite, hydromagnesite, wollastonite, magnesium hydroxide, and/or zinc borate is in the range of 20-65 wt%, or 20-60 wt%, or 20-50 wt%, or 20-45 wt%, or 20-40 wt%, or 20-35 wt%, or 20-30 wt%, or 25-60 wt%, or 25-50 wt%, or 25-45 wt%, or 25-40 wt%, or 25-35 wt%, or 30-60 wt%, or 30-50 wt%, or 30-45 wt%, or 30-40 wt%, or 35-60 wt%, or 35-55 wt%, or 35-50 wt%, or 35-40 wt%, or 40-60 wt%, or 40-55 wt%, or 40-50 wt%, or 45-60 wt%, or 45-55 wt%, or 50-60 wt% of the bituminous component.

Embodiment 18. The bituminous composition according to any of embodiments 1-17, wherein both huntite and hydromagnesite are present.

Embodiment 19. The bituminous composition according to embodiment 18, wherein the huntite and hydromagnesite are present in a huntite:hydromagnesite ratio in the range of 1:4 to 4:1 (e.g. in the range of 2:3 to 3:2).

Embodiment 20. The bituminous composition according to embodiment 18, wherein the huntite and hydromagnesite are present in a huntite:hydromagnesite ratio of 30:70 to 50:50, e.g., about 2:3.

Embodiment 21. The bituminous composition according to any of embodiments 18-20, wherein the huntite and hydromagnesite are present in a total amount in the range of 10-70 wt%, e.g., 10-65 wt.%, or 10-60 wt%, or 10-55 wt%, or 10-50 wt%, or 10-45 wt%, or 10-40 wt%, or 10-35 wt%, or 10-30 wt%, or 10-25 wt%, or 10-20 wt%, or 15-60 wt%, or 15-55 wt%, or 15-50 wt%, or 15-45 wt%, or 15-40 wt%, or 15-35 wt%, or 15-30 wt%, or 15-25 wt% of the bituminous component.

Embodiment 22. The bituminous composition according to any of embodiments 18-20, wherein the huntite and hydromagnesite are present in a total amount in the range of 20-70 wt%, e.g., 20-65 wt.%, or 20-60 wt%, or 20-55 wt%, or 20-50 wt%, or 20-45 wt%, or 20-40 wt%, or 20-35 wt%, or 20-30 wt%, or 25-60 wt%, or 25-55 wt%, or 25-50 wt%, or 25-45 wt%, or 25-40 wt%, or 25-35 wt% of the bituminous component.

Embodiment 23. The bituminous composition according to any of embodiments 18-20, wherein the huntite and hydromagnesite are present in a total amount in the range of 30-70 wt%, e.g., 30-65 wt.%, or 30-60 wt%, or 30-55 wt%, or 30-50 wt%, or 30-45 wt%, or 30-40 wt%, or 35-60 wt%, or 35-55 wt%, or 35-50 wt%, or 35-45 wt% of the bituminous component.

Embodiment 24. The bituminous composition according to any of embodiments 18-20, wherein the huntite and hydromagnesite are present in a total amount in the range of 40-70 wt%, e.g., 40-65 wt.%, or 40-60 wt%, or 40-55 wt%, or 40-50 wt%, or 45-60 wt%, or 45-55 wt%, or 50-60 wt% of the bituminous component.

Embodiment 25. The bituminous composition according to any of embodiments 1-24, wherein wollastonite is present.

Embodiment 26. The bituminous composition according to embodiment 25, wherein the wollastonite is present together with huntite and hydromagnesite.

Embodiment 27. The bituminous composition according to embodiment 25, wherein the wollastonite is present together with huntite, hydromagnesite and zinc borate.

Embodiment 28. The bituminous composition according to any of embodiments 25-27, wherein the wollastonite is present in an amount in the range of 10-70 wt%, e.g., 10-65 wt.%, or 10-60 wt%, or 10-55 wt%, or 10-50 wt%, or 10-45 wt%, or 10-40 wt%, or 10-35 wt%, or 10-30 wt%, or 10-25 wt%, or 10-20 wt%, or 15-60 wt%, or 15-55 wt%, or 15-50 wt%, or 15-45 wt%, or 15-40 wt%, or 15-35 wt%, or 15-30 wt%, or 15-25 wt% of the bituminous component.

Embodiment 29. The bituminous composition according to any of embodiments 25-27, wherein the wollastonite is present in an amount in the range of 20-70 wt%, e.g., 20-65 wt.%, or 20-60 wt%, or 20-55 wt%, or 20-50 wt%, or 20-45 wt%, or 20-40 wt%, or 20-35 wt%, or 20-30 wt%, or 25-60 wt%, or 25-55 wt%, or 25-50 wt%, or 25-45 wt%, or 25-40 wt%, or 25-35 wt% of the bituminous component.

Embodiment 30. The bituminous composition according to any of embodiments 25-27, wherein the wollastonite is present in an amount in the range of 30-70 wt%, e.g., 30-65 wt.%, or 30-60 wt%, or 30-55 wt%, or 30-50 wt%, or 30-45 wt%, or 30-40 wt%, or 35-60 wt%, or 35-55 wt%, or 35-50 wt%, or 35-45 wt% of the bituminous component.

Embodiment 31. The bituminous composition according to any of embodiments 25-27, wherein the wollastonite is present in an amount in the range of 40-70 wt%, e.g., 40-65 wt.%, or 40-60 wt%, or 40-55 wt%, or 40-50 wt%, or 45-60 wt%, or 45-55 wt%, or 50-60 wt% of the bituminous component.

Embodiment 32. The bituminous composition according to any of embodiments 25-27, wherein the wollastonite is present in an amount up to 20 wt%, e.g., up to 15%, or up to 10%, for example, in the range of 5-20 wt%, or 5-15 wt%, or 1-10 wt%.

Embodiment 33. The bituminous composition according to any of embodiments 1-18, wherein magnesium hydroxide and zinc borate are present.

Embodiment 34. The bituminous composition according to embodiment 33, wherein the magnesium hydroxide is present in an amount in the range of 10-70 wt%, e.g., 20-65 wt.%, or 20-60 wt%, or 10-59 wt%, or 10-55 wt%, or 10-50 wt%, or 10-45 wt%, or 10-40 wt%, or 10-35 wt%, or 10-30 wt%, or 10-25 wt%, or 10-20 wt%, or 15-60 wt%, or 15-55 wt%, or 15-50 wt%, or 15-45 wt%, or 15-40 wt%, or 15-35 wt%, or 15-30 wt%, or 15-25 wt% of the bituminous component.

Embodiment 35. The bituminous composition according to embodiment 33, wherein the magnesium hydroxide is present in an amount in the range of 20-70 wt%, e.g., 20-65 wt.%, or 20-60 wt%, or 20-55 wt%, or 20-50 wt%, or 20-45 wt%, or 20-40 wt%, or 20-35 wt%, or 20-30 wt%, or 25-60 wt%, or 25-55 wt%, or 25-50 wt%, or 25-45 wt%, or 25-40 wt%, or 25-35 wt% of the bituminous component.

Embodiment 36. The bituminous composition according to embodiment 33, wherein the magnesium hydroxide is present in an amount in the range of 30-70 wt%, e.g., 30-65 wt.%, or 30-60 wt%, or 30-55 wt%, or 30-50 wt%, or 30-45 wt%, or 30-40 wt%, or 35-60 wt%, or 35-55 wt%, or 35-50 wt%, or 35-45 wt% of the bituminous component.

Embodiment 37. The bituminous composition according to embodiment 30, wherein the magnesium hydroxide is present in an amount in the range of 40-70 wt%, e.g., 40-65 wt.%, or 40-60 wt%, or 40-55 wt%, or 40-50 wt%, or 45-60 wt%, or 45-55 wt%, or 50-60 wt% of the bituminous component.

Embodiment 38. The bituminous composition according to any of embodiments 1-37, wherein zinc borate is present.

Embodiment 39. The bituminous composition according to embodiment 38, wherein the zinc borate is present in an amount up to 20 wt%, e.g., up to 15 wt% or up to 10 wt% of the bituminous component.

Embodiment 40. The bituminous composition according to embodiment 38, wherein the zinc borate is present in an amount of 1-20 wt% (e.g., in an amount in the range of 1-15 wt%, or 1-10 wt%, or 1-5 wt%, or 2-20 wt%, or 2-15 wt%, or 2-10 wt%, or 5-20 wt%, or 5-15 wt%, or 10- 20 wt%) of the bituminous component.

Embodiment 41. The bituminous composition according to any of embodiments 1-40, having a viscosity at 375° F. in the range of 3500 to 8000 cP (e.g. in the range of 4000 to 8000 cP, or 4500 to 8000 cP, or 5000 to 8000 cP, or 3500 to 7500 cP, or 4000 to 7500 cP, or 4500 to 7500 cP, or 5000 to 7500 cP, or 3500 to 7000 cP, or 4000 to 7000 cP, or 4500 to 7000 cP, or 5000 to 7000 cP).

Embodiment 42. The bituminous composition according to any of embodiments 1-41, having a penetration index at 77° F. of no more than 50 dmm, (e.g., no more than 40 dmm).

Embodiment 43. The bituminous composition according to any of embodiments 1-42, having a penetration index at 77° F. of at least 15 dmm (e.g., at least 20 dmm, or at least 25 dmm).

Embodiment 44. The bituminous composition according to any of embodiments 1-41, having a penetration index at 77° F. in the range of 20-70 dmm, e.g., 30-70 dmm, or 40-70 dmm, or 20-60 dmm, or 30-60 dmm, or 40-60 dmm, or 20-50 dmm, or 30-50 dmm, or 40-50 dmm.

Embodiment 45. The bituminous composition according to any of embodiments 1-44, having a penetration index at 32° F. of no more than 30 dmm (e.g., no more than 25 dmm, or no more than 20 dmm).

Embodiment 46. The bituminous composition according to any of embodiments 1-45, having a penetration index at 32° F. of at least 5 dmm (e.g., of at least 10 dmm, or 15 dmm).

Embodiment 47. The bituminous composition according to any of embodiments 1-46, having a penetration index at 115° F. or no more than 70 dmm (e.g., no more than 60 dmm, or 50 dmm).

Embodiment 48. The bituminous composition according to any of embodiments 1-47, having a penetration index at 115° F. of at least 20 dmm (e.g. at least 30 dmm, or 30 dmm).

Embodiment 49. The bituminous composition according to any of embodiments 1-48, having a softening point of at least 200° F., e.g., at least 225° F., or at least 250° F., as measured by ASTM D36M.

Embodiment 50. The bituminous composition according to any of embodiments 1-49, having a softening point of no more than 320° F., e.g., no more than 310° F., or no more than 300° F., or no more than 290° F., as measured by ASTM D36M.

Embodiment 51. The bituminous composition according to any of embodiments 1-48, having a softening point in the range of 200-320 ° F., e.g., 225-320 ° F., or 250-320 ° F., or 200-310 ° F., or 225-310 ° F., or 250-310 ° F., or 200-300 ° F., or 225-300 ° F., or 250-300 ° F., 200-290 ° F., or 225-290 ° F., or 250-290 ° F.

Embodiment 52. A roofing shingle comprising:

a porous substrate; at least one layer of the bituminous composition according to any of embodiments 1-51 having a top surface and disposed on the porous substrate; and a plurality of roofing granules adhered upon the top surface of the at least one layer of the bituminous composition.

Embodiment 53. The roofing shingle according to embodiment 52, having a class A rating under ASTM E108 ata slope of at least 0.5:12 (e.g., at least 1:12 or 2:12).

Embodiment 54. The roofing shingle according to embodiment 52 or 53, having a class A rating under ASTM E108 ata slope in the range of 0.5:12 to 5:12.

Embodiment 55. A roofing membrane comprising the bituminous composition according to any of embodiments 1-51, disposed on at least one side of a porous substrate.

Embodiment 56. The roofing membrane according to embodiment 55, having a class A rating under ASTM E108 at a slope of at least 0.5:12 (e.g., at least 1:12 or 2:12).

Embodiment 57. The roofing membrane according to embodiment 55 or 56, having a class

A rating under ASTM E108 ata slope in the range of 0.5:12 to 2:12.

Embodiment 58. A roofing system comprising:

a roof structure; and a plurality of roofing shingles according to any of embodiments 52-54 or a roofing membrane according to any of embodiments 55-57 disposed on the roof structure.

Embodiment 59. The roofing system of embodiment 58, wherein the roofing system has a slope in the range of 0.25:12 - 12:12 (e.g., in the range of 0.5:12 to 6:12, or 0.5:12 to 5:12, or 0.5:12 to 4:12, or 0.5:12 to 3:12, or 1:12 to 12:12, or 1:12 to 6:12, or 1:12 to 5:12, or 1:12 to 4:12, or 1:12 to 3:12, or 2:12 to 12:12, or 2:12 to 6:12, or 2:12 to 5:12, or 2:12 to 4:12, or 2:12 to 3:12).

Embodiment 60. The roofing system of embodiment 58, wherein the roofing system comprises a plurality of roofing shingle according to any of embodiments 52-54 disposed on the roof structure and wherein the roofing system has a slope in the range of 2:12 to 12:12.

Embodiment 61. The roofing system of embodiment 58, wherein the roofing system comprises a roofing membrane according to any of embodiments 55-57 disposed on the roof structure and wherein the roofing system has a slope in the range of 0.25:12 to 5:12.

It will be apparent to those skilled in the art that various modifications and variations can be made to the processes and devices described here without departing from the scope of the disclosure. Thus, it is intended that the present disclosure cover such modifications and variations of this invention provided they come within the scope of the appended claims and their equivalents.

What is claimed is:

1. A bituminous composition suitable for use in roofing materials, the bituminous composition comprising a bituminous component comprising:
an asphalt component in an amount in the range of 75-95 wt% of the bituminous component;
a rubber polymer in an amount of 5-20 wt% of the bituminous component; and
a polyolefin wax in an amount up to 5 wt% of the bituminous component; and
dispersed within the bituminous component, a filler component comprising at least one of both huntite and hydromagnesite;
wollastonite; and
both magnesium hydroxide and zinc borate, wherein a total amount of huntite, hydromagnesite, wollastonite, magnesium hydroxide and zinc borate is in the range of 20-70 wt% of the bituminous component.

2. The bituminous composition according to claim 1, wherein the asphalt component has a pen range lying above 100 pen.

3. The bituminous composition according to claim 1, wherein the asphalt component is a 150-200 pen asphalt.

4. The bituminous composition according to claim 1, wherein the asphalt component is present in an amount in the range of 80-95 wt% of the bituminous component.

5. The bituminous composition according to claim 1, wherein the rubber polymer comprises (or is) one or more styrene block copolymers.

6. The bituminous composition according to claim 1, wherein the polyolefin wax is a polyethylene wax, a polypropylene wax, or a wax copolymer of ethylene and propylene.

7. The bituminous composition according to claim 1, wherein the polyolefin wax is present in an amount in the range of 0.5-4 wt% of the bituminous component.

8. The bituminous composition according to claim 1, wherein the total amount of the huntite, hydromagnesite, wollastonite, magnesium hydroxide, and/or zinc borate is in the range of 20-65 wt% of the bituminous component.

9. The bituminous composition according to claim 1, wherein both huntite and hydromagnesite are present.

10. The bituminous composition according to claim 9, wherein the huntite and hydromagnesite are present in a huntite:hydromagnesite ratio in the range of 1:4 to 4:1.

11. The bituminous composition according to claim 1, wherein wollastonite is present.

12. The bituminous composition according to claim 11, wherein the wollastonite is present together with huntite and hydromagnesite.

13. The bituminous composition according to claim 11, wherein the wollastonite is present together with huntite, hydromagnesite and zinc borate.

14. The bituminous composition according to claim 1, wherein magnesium hydroxide and zinc borate are present.

15. The bituminous composition according to claim 1, wherein zinc borate is present.

16. The bituminous composition according to claim 1, having a viscosity at 375° F. in the range of 3500 to 8000 cP.

17. The bituminous composition according to claim 1, having a penetration index at 77° F. in the range of 20-70 dmm.

18. A roofing shingle comprising:
a porous substrate;
at least one layer of the bituminous composition according to claim 1 having a top surface and disposed on the porous substrate; and
a plurality of roofing granules adhered upon the top surface of the at least one layer of the bituminous composition.

19. A roofing system comprising:
a roof structure; and
disposed on the roof structure, a plurality of roofing shingles according to claim 18.

20. The roofing system of claim 19, wherein the roofing system has a slope in the range of 2:12 to 12:12.

21. A roofing membrane comprising the bituminous composition according to claim 1, disposed on at least one side of a porous substrate.
